(19) United States
(12) Patent Application Publication
(10) Pub. No.: US 2015/0226538 A1
(43) Pub. Date: Aug. 13, 2015

(54) GRAZING INCIDENCE INTERFEROMETER

(71) Applicant: MITUTOYO CORPORATION, Kanagawa (JP)

(72) Inventors: Reiya OTAO, Ibaraki (JP); Yutaka KURIYAMA, Ibaraki (JP)

(73) Assignee: MITUTOYO CORPORATION, Kanagawa (JP)

(21) Appl. No.: 14/617,018

(22) Filed: Feb. 9, 2015

(30) Foreign Application Priority Data
Feb. 13, 2014 (JP) 2014-025307

(51) Int. Cl. G01B 9/02; G01B 11/24

(52) U.S. Cl. CPC G01B 9/02022; G01B 9/02041; G01B 11/2441

(57) ABSTRACT

A grazing incidence interferometer includes: a graduated instrument showing an index at an overlapping area where adjacent ones of measurement areas overlap with each other; and a measuring unit including: an image acquiring unit that acquires interference fringe images at image-capturing positions for the measurement areas, individually, the interference fringe images each showing each of the measurement areas and the index; and a profile computing unit that combines measurement results based on the interference fringe images of the adjacent ones of the measurement areas in a manner that images of the index included in common in the interference fringe images of the adjacent ones of the measurement areas are superimposed on each other.

The entire disclosure of Japanese Patent Application No. 2014-025307 filed Feb. 13, 2014 is expressly incorporated by reference herein.

### TECHNICAL FIELD

The present invention relates to a grazing incidence interferometer.

### BACKGROUND ART

Typical normal-incidence interferometers, which enable a highly accurate measurement on the basis of optical wavelength, are not configured to measure a profile of a workpiece with a discontinuous level difference equal to or larger than the half of the wavelength or a workpiece with a large undulation having a level variation equal to or larger than the half of the wavelength between the pixels of adjacent images.

In contrast, grazing incidence interferometers are known to measure a large unevenness (see, for instance, Patent Literature 1: JP-A-2010-32342).

Grazing incidence interferometers obliquely apply a beam to be reflected, so that the wavelength is seemingly lengthened and thus a variation of a measured wavefront relative to an unevenness of a workpiece can be intentionally reduced. Further, a measurement beam obliquely incident is reflected to be oriented, so that clear interference fringes as on a mirrored surface can appear even on a rough surface.

In grazing incidence interferometers, a distance showing an optical path length difference per one wavelength is typically referred to as fringe sensitivity, which is represented by level difference Λ=λ/2 cos θ (μm) for each interference fringe (λ: a measurement beam wavelength, θ: an incident angle).

The fringe sensitivity is determined by the incident angle of a measurement beam and the wavelength of a laser (a light source). For instance, given that the wavelength of the laser is fixed, the fringe sensitivity is determined only by the incident angle. Accordingly, a surface texture of a workpiece and required measurement accuracy are taken into consideration to determine the incident angle.

Workpieces to be measured by grazing incidence interferometers include a workpiece having a surface with a relatively large undulation, which is unlikely to be measured by normal-incidence interferometers, as described above and a workpiece having a rough surface (a non-mirrored surface). Examples of the above include a variety of wafers and glass for FPD (Flat-Panel Display). In machining these workpieces having been getting larger and larger, it is generally important to control flatness before a polishing process, so that it is highly demanded to control the flatness of a large-sized highly accurate non-mirrored surface.

In order to control the flatness of such a large-sized highly accurate non-mirrored surface, a grazing incidence interferometer may be used to measure a large area. In this case, the following two methods are available.

According to one of the measurement methods, the incident angle of a measurement beam is increased.

Specifically, when the incident angle is increased, a laser beam is longitudinally enlarged over the original diameter thereof into an oval shape, which results in an increased measurement area. However, measurement resolution is inevitably lowered, so that this method is unsuitable in some cases.

In the other method, stepping/scanning measurement is performed with a grazing incidence interferometer.

Specifically, a measurement surface is divided into several areas, which are sequentially subjected to measurement, and measurement results are combined to obtain the entire profile. Therefore, the measurement can be performed while a vertical resolution is kept. However, measurement accuracy should be lowered due to a stitching error in combining the measurement results.

### SUMMARY OF THE INVENTION

An object of the invention is to provide a grazing incidence interferometer capable of increasing a measurement area while suppressing a decrease in measurement accuracy.

In a first aspect of the invention, a grazing incidence interferometer includes: a light source; a beamsplitter configured to split raw light from the light source into a measurement beam and a reference beam; a light irradiator configured to obliquely apply the measurement beam to a plurality of measurement areas defined in a target surface, individually; a beam combiner configured to combine the measurement beam reflected by the target surface and the reference beam into a combined beam; an image capturing unit configured to capture interference fringe images of the measurement areas based on the combined beam; an interferometer body in which the light source, the beamsplitter, the light irradiator, the beam combiner and the image capturing unit are disposed; a base configured to hold a workpiece having the target surface; a relative movement mechanism configured to relatively move the interferometer body and/or the base in a manner that the measurement areas are aligned with one another and adjacent ones of the measurement areas partly overlap with each other; an index displaying unit configured to show an index at a position where the adjacent ones of the measurement areas overlap with each other; and a measuring unit configured to combine measurement results based on the interference fringe images of the measurement areas to obtain a surface profile of the target surface, the measuring unit including: an image acquiring unit configured to acquire the interference fringe images of the measurement areas at image-capturing positions for the measurement areas, individually, the interference fringe images each showing the index and one of the measurement areas; and a profile computing unit configured to combine the measurement results based on the interference fringe images of the adjacent ones of the measurement areas in a manner that images of the index included in common in the interference fringe images of the adjacent ones of the measurement areas are superimposed on each other to obtain the surface profile.

In the above aspect of the invention, the measuring unit combines measurement results based on a plurality of interference fringe images in such a manner that images of the index included in common in the interference fringe images of adjacent ones of the measurement areas are superimposed on each other to obtain a measurement result of the target surface. Therefore, a stitching error in combining the measurement results can be eliminated to suppress a decrease in measurement accuracy. Further, combining the plurality of measurement results in an increased measurement range, so that a decrease in measurement resolution can be suppressed without increasing the incident angle.

In the above aspect of the invention, it is preferable that the index displaying unit includes an index projector configured to project the index on the target surface.

The index displaying unit may be a member made of metal or the like independent of a workpiece, the member being provided with the index by fluting or vapor deposition. However, in this case, since the target surface needs to be focused on in image-capturing, it is requisite to dispose the index displaying unit with the index being flush with the target surface. Further, both the workpiece and the index displaying unit need to be in a view at the same time, which results in a reduction in a measurement range.

However, with the above arrangement, the index projector projects the index, so that the index can appear on the target surface anytime as required without adjusting the level of the index. Further, only the workpiece needs to be image-captured, which results in suppressing a reduction in the measurement range.

In the above aspect of the invention, it is preferable that the grazing incidence interferometer further includes an image capturing state switching unit configured to switch: a first image capturing state where the raw light from the light source is to be incident on the image capturing unit whereas a projection beam from the index projector is not to be incident on the image capturing unit; and a second image capturing state where at least the projection beam out of the raw beam and the projection beam is to be incident on the image capturing unit, in which the image acquiring unit controls the image capturing state switching unit at the image-capturing positions for the measurement areas to acquire the interference fringe images of the measurement areas, individually, the interference fringe images each including: a first interference fringe image that is captured in the first image capturing state and shows the one of the measurement areas but not shows the index; and a second interference fringe image that is captured in the second image capturing state and shows the index, and the profile computing unit: computes a positional relationship between the second interference fringe images of the adjacent ones of the measurement areas in which the images of the index included in common in the second interference fringe images of the adjacent ones of the measurement areas are superimposed on each other; and combines the measurement results based on the first interference fringe images of the adjacent ones of the measurement areas in conformity with the positional relationship.

A surface profile obtained by combining measurement results showing the index has a void corresponding to the index, which results in a failure in obtaining a measurement result based on the entire image-captured measurement areas.

However, with the above arrangement, the measuring unit calculates a positional relationship in which images of the index included in common in the second interference fringe images of adjacent ones of the measurement areas are superimposed on each other, and combines measurement results based on the corresponding first interference fringe images, which show no index, in conformity with the positional relationship. Therefore, the resulting surface profile is devoid of a void corresponding to the index, which results in obtaining a measurement result based on the entire image-captured measurement areas.

In the above aspect of the invention, it is preferable that a wavelength of the raw light is defined as a first wavelength, a wavelength of the projection beam from the index projector is defined as a second wavelength different from the first wavelength, and the image capturing state switching unit includes: a filter configured to transmit light with the first wavelength but not light with the second wavelength; and a filter moving unit configured to move the filter into an optical path of the combined beam to achieve the first image capturing state and move the filter out of the optical path of the combined beam to achieve the second image capturing state.

In a second aspect of the invention, a grazing incidence interferometer includes: a light source; a beamsplitter configured to split raw light from the light source into a measurement beam and a reference beam; a light irradiator configured to obliquely apply the measurement beam to a plurality of measurement areas defined in a target surface, individually; a beam combiner configured to combine the measurement beam reflected by the target surface and the reference beam into a combined beam; an image capturing unit configured to capture interference fringe images of the measurement areas based on the combined beam; an interferometer body in which the light source, the beamsplitter, the light irradiator, the beam combiner and the image capturing unit are disposed; a base configured to hold a workpiece having the target surface; a relative movement mechanism configured to relatively move the interferometer body and/or the base in a manner that the plurality of measurement areas are aligned with one another and adjacent ones of the measurement areas partly overlap with each other; an index displaying unit including an index projector configured to project an index to a position where the adjacent ones of the measurement areas overlap with each other; and an index-image capturing unit disposed in the interferometer body at a position where the combined beam is not incident to capture index images of the measurement areas showing the index in the measurement areas; an image capturing state setting unit configured to achieve a state where the interference fringe images showing the measurement areas but not showing the index are to be captured by the image capturing unit whereas the index images showing the index are to be captured by the index-image capturing unit; and a measuring unit configured to combine measurement results based on the interference fringe images of the measurement areas to obtain a surface profile of the target surface, the measuring unit including: an image acquiring unit configured to acquire the interference fringe images and the index images of the measurement areas at image-capturing positions for the measurement areas, individually; a profile computing unit configured to obtain the surface profile by: computing a positional relationship between the index images of the adjacent ones of the measurement areas in which images of the index included in common in the index images are superimposed on each other; and combining the measurement results based on the interference fringe images of the adjacent ones of the measurement areas in conformity with the positional relationship.

In the above aspect of the invention, the measuring unit obtains the measurement result of the target surface by computing a positional relationship in which images of the index included in common in adjacent ones of the index images are superimposed on each other and combining measurement results based on the interference fringe images corresponding to these index images in conformity with the positional relationship. Therefore, a stitching error in combining the measurement results can be eliminated to suppress a decrease in measurement accuracy. Further, combining the plurality of measurement results in an increased measurement range, so that a decrease in measurement resolution can be suppressed without increasing the incident angle. Further, since measurement results based on the interference fringe images showing no index are combined, the resulting surface profile is devoid of a void corresponding to the index.

In the above aspect of the invention, it is preferable that a wavelength of the raw light is defined as a first wavelength, a wavelength of a projection beam from the index projector is defined as a second wavelength different from the first wavelength, and the image capturing state setting unit includes a wavelength selector disposed in an optical path of the combined beam so that light with the first wavelength is to be incident on the image capturing unit whereas light with the second wavelength is not to be incident on the image capturing unit.

With the above arrangement, even when the index is continuously projected by the index projector and thus continues to appear on the target surface, the interference fringe image that shows no index and is devoid of a void corresponding to the index and the index image that shows the index can be captured, thereby obtaining a measurement result based on the entire image-captured measurement areas. Further, with a combination of the image capturing unit and the index-image capturing unit, the interference fringe image and the index image of each of the measurement areas can be simultaneously captured so that measurement time can be reduced.

### BRIEF DESCRIPTION OF DRAWING(S)

FIG. 1 is a perspective view of an overall arrangement of a grazing incidence interferometer according to a first exemplary embodiment of the invention.

FIG. 2 schematically shows an interior of an interferometer body according to the first exemplary embodiment.

FIG. 3A illustrates a process for combining measurement results according to the first exemplary embodiment.

FIG. 3B illustrates the process for combining the measurement results according to the first exemplary embodiment.

FIG. 3C illustrates the process for combining the measurement results according to the first exemplary embodiment.

FIG. 4 schematically shows an interior of an interferometer body of a grazing incidence interferometer according to a second exemplary embodiment of the invention.

FIG. 5 is a perspective view of an index projector according to the second exemplary embodiment.

FIG. 6 is a side view of the index projector and an index-image capturing unit according to the second exemplary embodiment.

FIG. 7A schematically shows an interference fringe image according to the second exemplary embodiment, an interference fringe image according to a third exemplary embodiment of the invention or a first interference fringe image according to a fourth exemplary embodiment of the invention.

FIG. 7B schematically shows an index image according to the second exemplary embodiment, an index image according to the third exemplary embodiment of the invention or a second interference fringe image according to the fourth exemplary embodiment of the invention.

FIG. 8 schematically shows an interior of an interferometer body of a grazing incidence interferometer according to the third exemplary embodiment of the invention.

FIG. 9 schematically shows an interior of an interferometer body of a grazing incidence interferometer according to a fourth exemplary embodiment of the invention.

FIG. 10 is a perspective view of an index projector according to a modification of the invention.

FIG. 11A schematically shows an image capturing state switching unit according to another modification of the invention.

FIG. 11B schematically shows the image capturing state switching unit according to the modification shown in FIG. 11A.

### DESCRIPTION OF EMBODIMENT(S)

### First Exemplary Embodiment

First, a grazing incidence interferometer according to a first exemplary embodiment of the invention will be described.

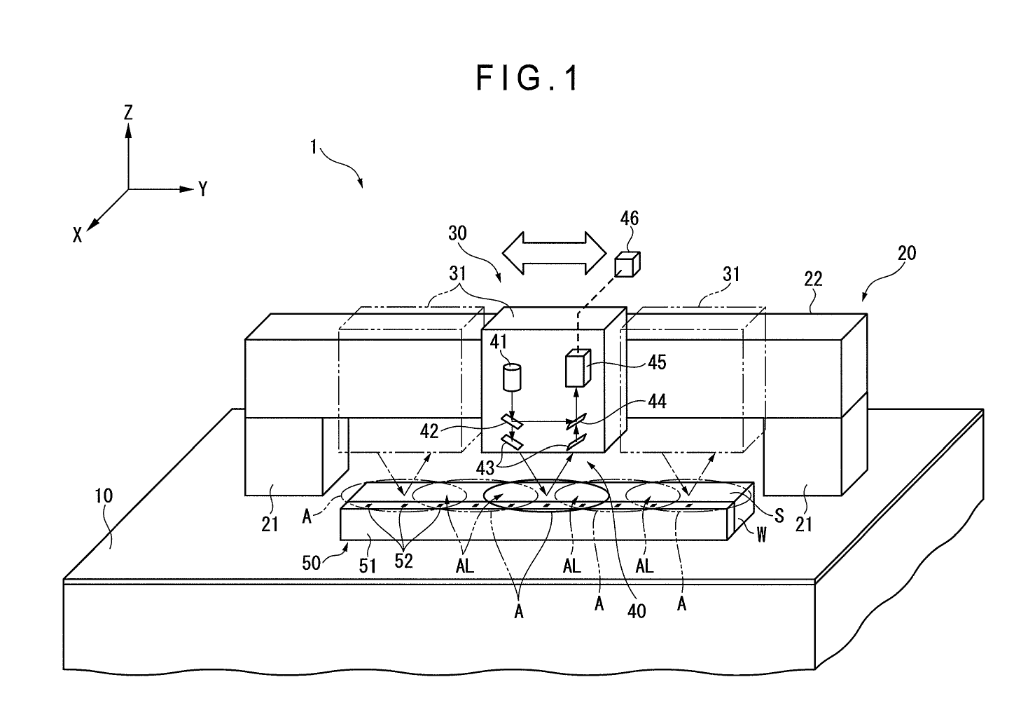

As shown in FIG. 1, a grazing incidence interferometer 1 includes: a base 10 for holding a workpiece W with a target surface S; a relative movement mechanism 20 disposed on the base 10; an interferometer body 30 supported on the relative movement mechanism 20; and a graduated instrument 50 serving as an index displaying unit.

The base 10, which is similar to a surface plate in a coordinate measuring machine or the like, has an upper surface that is precisely horizontal.

The relative movement mechanism 20 includes: a pair of columns 21 vertically provided on the upper surface of the base 10; a beam 22 disposed on the columns 21 and provided with a carriage (not shown) movable in a Y-axis direction along the beam 22.

The beam 22 includes a driving mechanism for driving the carriage and an encoder for detecting the displacement of the carriage (both not shown). With the above arrangement, in the relative movement mechanism 20, the carriage can be moved to a desired position along the beam 22 by the driving mechanism and the accurate current position of the carriage relative to the base 10 can be acquired by the encoder.

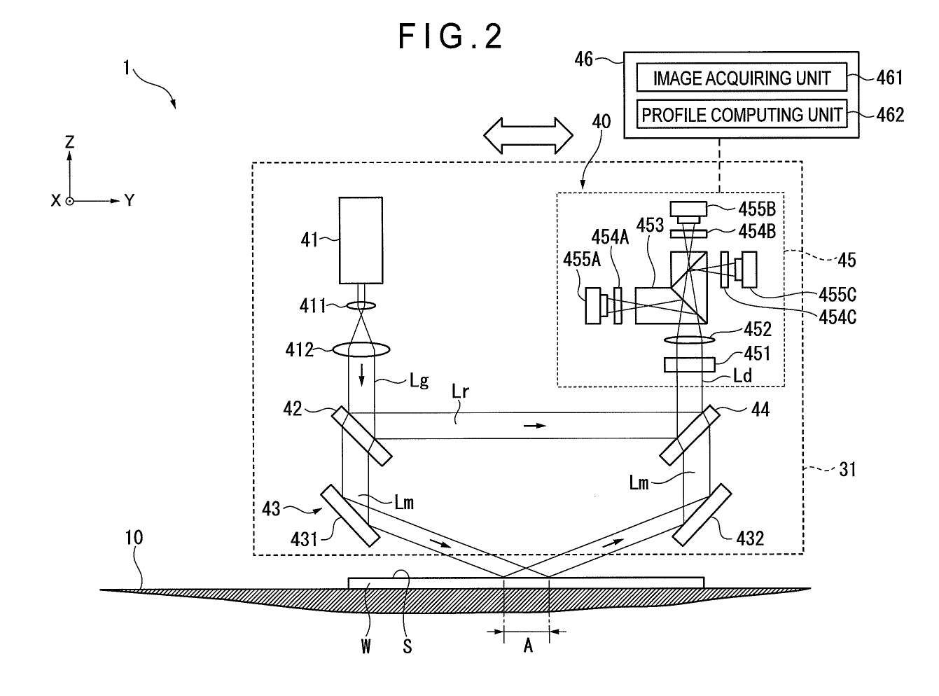

The interferometer body 30 includes a case 31 supported on the carriage of the relative movement mechanism 20, and an optical element serving as a measuring optical system 40 shown in FIG. 2 is provided in the case 31.

The measuring optical system 40 includes a light source 41, a beamsplitter 42, a light irradiator 43, a beam combiner 44 and an image capturing unit 45.

The light source 41 emits coherent raw light Lg.

The beamsplitter 42 splits the raw light Lg from the light source 41 into a measurement beam Lm and a reference beam Lr.

The light irradiator 43 obliquely applies the measurement beam Lm to each of measurement areas A defined in the target surface S.

The beam combiner 44 combines the measurement beam Lm reflected by the target surface S and the reference beam Lr from the beamsplitter 42 into a combined beam Ld.

The image capturing unit 45 receives the combined beam Ld provided by the beam combiner 44 and captures an interference fringe image of each of the measurement areas A based on the combined beam Ld.

The optical element serving as the above measuring optical system 40 will be described later in detail.

The interferometer body 30 can obtain a surface profile of the target surface S of the workpiece W with the assistance of the measuring optical system 40 provided to the interferometer body 30.

In determining the surface profile, when the interferometer body 30 stays at a predetermined position, one of the measurement areas A on the target surface S shown in FIG. 1 can be subjected to measurement. Although each of the measurement areas A is smaller than the target surface S of the workpiece W, the entire surface profile of the target surface S can be obtained by stepping measurement. Specifically, the entire surface profile can be obtained by: moving the interferometer body 30 to a plurality of positions with the relative movement mechanism 20 to define the plurality of measurement areas A aligned with one another in one direction, adjacent ones of the measurement areas A partly overlapping with each other; performing measurement at each of these positions; and combining measurement results of the measurement areas A obtained at these positions.

As shown in FIG. 1, the graduated instrument 50, which is set in contact or almost in contact with the workpiece W, has indexes 52 shown at least in overlapping areas AL where adjacent ones of the measurement areas A overlap with each other.

Specifically, the graduated instrument 50 includes a substantially stick-shaped instrument body 51 made of metal, glass or the like. The instrument body 51 has an upper surface on which the plurality of indexes 52 are aligned substantially at regular intervals along a direction in which the measurement areas A are aligned with one another, one of the indexes 52 being disposed in each of the overlapping areas AL. The indexes 52 are each in a rectangular shape in a plan view and formed flush with the target surface S by fluting or vapor deposition.

The light source 41 is preferably a light source, such as a He—Ne laser, that emits a laser beam that has a favorable coherence and is incident on the optical system of the grazing incidence interferometer 1 without a temporal change in a component ratio between p-polarized light and s-polarized light.

The raw light Lg emitted from the light source 41 enters the beamsplitter 42 after being converted into collimated beam with a larger beam diameter through first lens 411 and second lens 412. It should be noted that the wavelength of the raw light Lg is defined as a first wavelength.

The beamsplitter 42, which may be a polarizing beamsplitter, splits the raw light Lg from the light source 41 into two polarized beams with polarization directions shifted by 90 degrees, and outputs them as the measurement beam Lm and the reference beam Lr.

The polarizing beamsplitter includes, for instance, two optical glass plates and a polarization film with polarization dependency interposed therebetween. The polarization film has optical properties of reflecting an s-polarized light component of the collimated beam and transmitting a p-polarized light component thereof. Therefore, the raw light Lg obliquely incident on the polarization film can be split into the measurement beam Lm and the reference beam Lr with polarization axes shifted by 90 degrees.

The beamsplitter 42 may alternatively be a polarizing beamsplitter in a rectangular parallelepiped that includes two right-angle prisms made of an optical glass and the polarization film interposed therebetween.

One of the split beams, i.e., the measurement beam Lm, is outputted to the light irradiator 43 to be applied to the target surface S, and then enters the beam combiner 44. The other one of the split beams, i.e., the reference beam Lr, is directly outputted to the beam combiner 44.

The light irradiator 43 includes a first objective mirror 431 and a second objective mirror 432.

The first objective mirror 431 refracts the measurement beam Lm from the beamsplitter 42 to be incident on the target surface S at a predetermined incident angle. The incident angle relative to the target surface S is adjusted so that a sufficient measurement accuracy can be achieved.

The second objective mirror 432 refracts the measurement beam Lm reflected by the target surface S to be incident on the beam combiner 44. An angle of the second objective mirror 432 relative to the target surface S is adjusted as needed in the same manner as the first objective mirror 431.

Preferably, the first objective mirror 431 and the second objective mirror 432 should be disposed at the same level and angle so that a light-incidence side and a light-output side are symmetric with respect to the target surface S.

The beam combiner 44, which may be a polarizing beamsplitter similar to the beamsplitter 42, combines the measurement beam Lm from the light irradiator 43 and the reference beam Lr from the beamsplitter 42 with the optical axes thereof aligned with each other, and outputs them as a combined beam Ld to the image capturing unit 45.

The image capturing unit 45 includes a quarter-wave plate 451, a lens 452, a three-way splitting prism 453, polarizers 454A to 454C and image sensors 455A to 455C, and captures the combined beam Ld from the beam combiner 44 as an interference fringe image.

The quarter-wave plate 451 is disposed at an incident side of the three-way splitting prism 453 and converts the combined beam Ld from the beam combiner 44 into circular polarized light.

The three-way splitting prism is formed by, for instance, bonding flat surfaces of three prisms, so that the combined beam reflected and transmitted at bonded surfaces of the prisms is split into three beams.

The polarizers 454A to 454C and the image sensors 455A to 455C are disposed to receive the beams split in different three directions by the three-way splitting prism 453, respectively. The polarizers 454A to 454C are disposed with polarization axes thereof being directionally different from each other, so that the phases of interference fringes passing through the polarizers 454A to 454C are shifted by amounts corresponding to the directional differences. The interference fringes are then image-captured by the image sensors 455A to 455C.

The image capturing unit 45 is connected to a measuring unit 46, which may be a personal computer or the like.

The measuring unit 46 combines measurement results based on the interference fringe images of the plurality of measurement areas A to obtain the surface profile of the target surface S. As shown in FIG. 2, the measuring unit 46 includes an image acquiring unit 461 and a profile computing unit 462.

At an image-capturing position for each of the measurement areas A, the image acquiring unit 461 acquires an interference fringe image showing the measurement area A and the indexes 52. Subsequently, the image acquiring unit 461 performs a computing processing on interference fringes shown in the interference fringe image in accordance with a known phase shift method, and controls the relative movement mechanism 20 and the interferometer body 30 based on a stored operation control program to perform stepping measurement of the plurality of measurement areas A in the target surface S.

The profile computing unit 462 combines measurement results based on the interference fringe images of adjacent ones of the measurement areas A in such a manner that images of the index 52 included in common in the interference fringe images of these measurement areas A are superimposed on each other to obtain the surface profile of the target surface S.

An operation according to the first exemplary embodiment will be described.

First, the measuring unit 46 is activated. The image acquiring unit 461 moves the interferometer body 30 with the relative movement mechanism 20 so that the interferometer body 30 is set at a first measurement position (an image-capturing position where the interferometer body 30 can measure one of the measurement areas A), and performs measurement of the target surface S by capturing the interference fringe image of the one of the measurement areas A. Next, the image acquiring unit 461 moves the interferometer body 30 to another measurement position and again performs measurement of the target surface S. The above process is repeated at subsequent measurement positions.

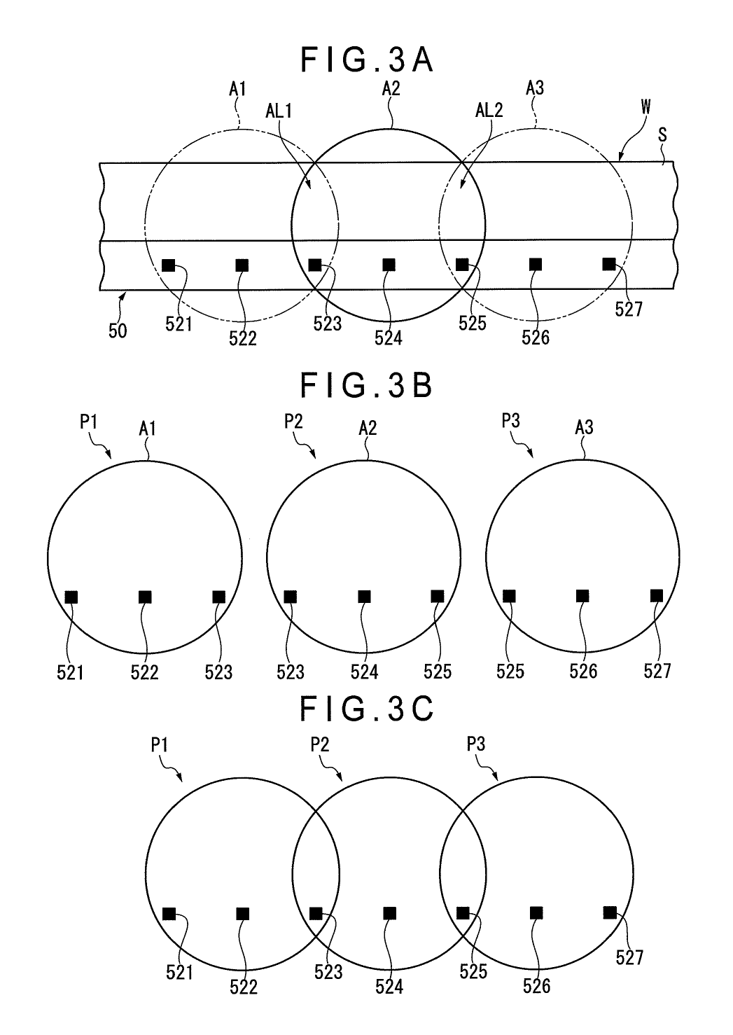

For instance, as shown in FIG. 3A, indexes 521 to 523, 523 to 525, 525 to 527 may respectively appear in measurement areas A1, A2, A3, the index 523 appearing in an overlapping area AL1 between the measurement area A1 and the measurement area A2, the index 525 appearing in an overlapping area AL2 between the measurement area A2 and the measurement area A3. In this case, as shown in FIG. 3B, the image acquiring unit 461 sequentially acquires an interference fringe image P1 showing the measurement area A1 and the indexes 521, 522, 523, an interference fringe image P2 showing the measurement area A2 and the indexes 523, 524, 525, and an interference fringe image P3 showing the measurement area A3 and the indexes 525, 526, 527. Then, based on the interference fringe images P1, P2, P3, the image acquiring unit 461 obtains measurement results of the measurement areas A1, A2, A3.

When measurement is completed at all the measurement positions, the profile computing unit 462 of the measuring unit 46 combines measurement results based on the interference fringe images of adjacent ones of the measurement areas A with the assistance of the indexes 52 to obtain a measurement result of the entire target surface S.

For instance, as shown in FIG. 3C, the profile computing unit 462: computes a positional relationship between the interference fringe image P1 and the interference fringe image P2 in which images of the index 523 included in both the interference fringe image P1 and the interference fringe image P2 are superimposed on each other; and combines a measurement result based on the interference fringe image P1 and a measurement result based on the interference fringe image P2 in conformity with the positional relationship. Here, the expression “images of the index 523 included in both the interference fringe image P1 and the interference fringe image P2 are superimposed on each other” means that the images of the index 523 in the images P1, P2 are completely superimposed on each other without any misalignment. Based on the positional relationship between the interference fringe image P2 and the interference fringe image P3 in which images of the index 525 are superimposed on each other, the profile computing unit 462 combines a measurement result based on the interference fringe image P2 and a measurement result based on the interference fringe image P3. The profile computing unit 462 repeats the above process for the other measurement areas to obtain the surface profile of the target surface S.

The first exemplary embodiment provides the following effect (1).
(1) The measuring unit 46 combines measurement results based on the plurality of interference fringe images in such a manner that images of the index 52 included in common in the interference fringe images of adjacent ones of the measurement areas A are superimposed on each other to obtain a measurement result of the target surface S. Therefore, a stitching error in combining the measurement results can be eliminated to suppress a decrease in measurement accuracy. Further, combining the plurality of measurement results in an increased measurement range, so that a decrease in measurement resolution can be suppressed without the necessity of increasing the incident angle.

### Second Exemplary Embodiment

Next, a grazing incidence interferometer according to a second exemplary embodiment of the invention will be described.

It should be noted that arrangements similar to those of the first exemplary embodiment are attached with the like reference signs and explanation thereof is omitted.

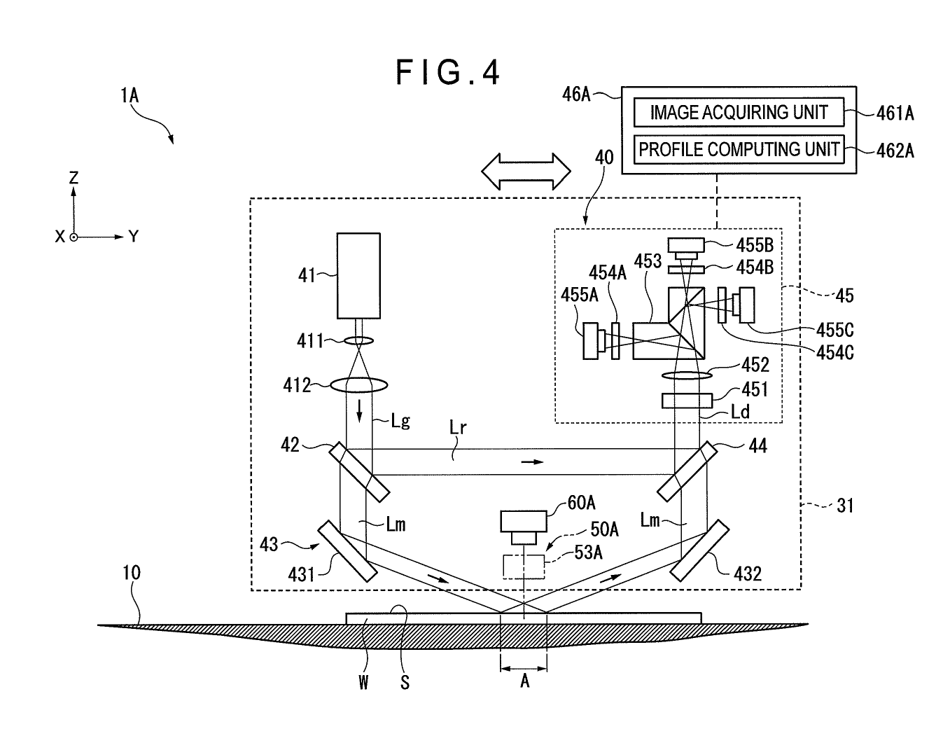

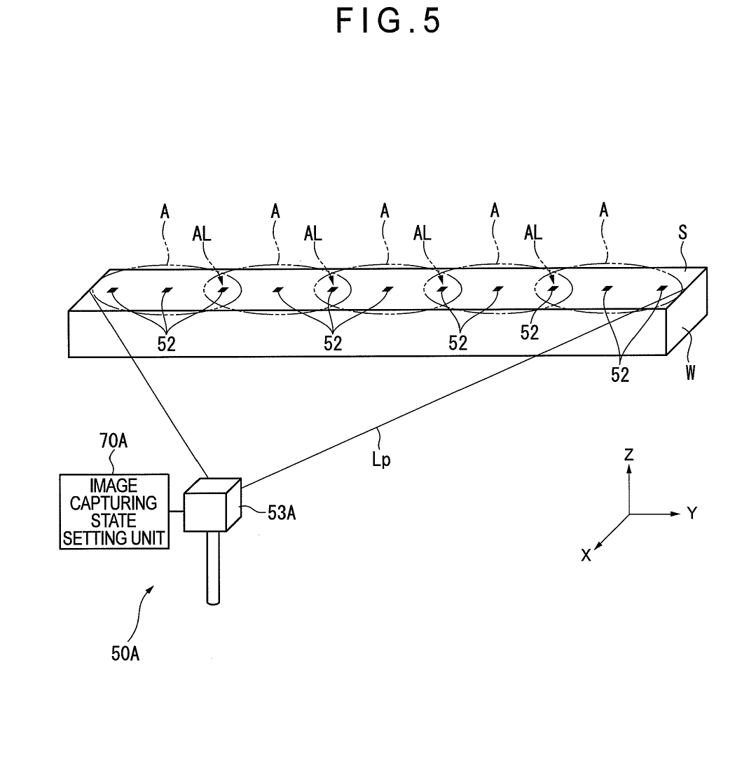

As shown in FIGS. 4 and 5, a grazing incidence interferometer 1A is different from the grazing incidence interferometer 1 of the first exemplary embodiment in that a measuring unit 46A and an index displaying unit 50A are provided in place of the measuring unit 46 and the graduated instrument 50 and an index-image capturing unit 60A and an image capturing state setting unit 70A are newly added.

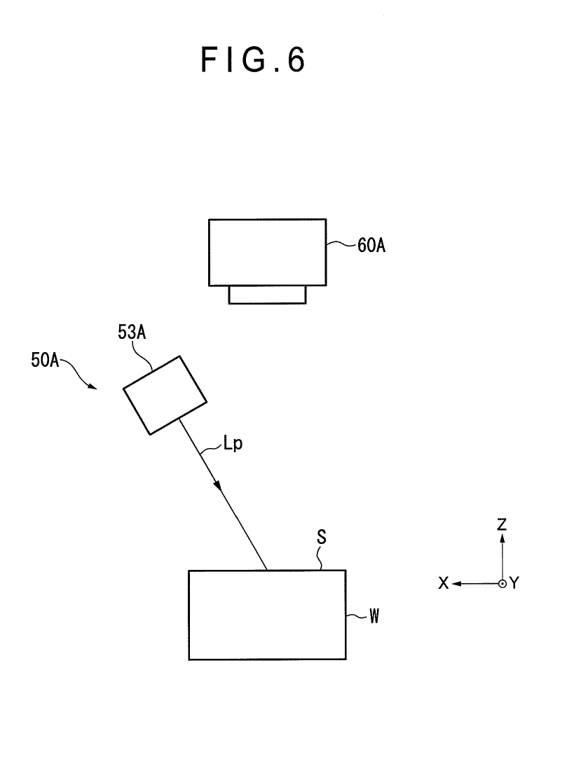

As shown in FIGS. 4 to 6, the index displaying unit 50A includes an index projector 53A that projects the plurality of indexes 52 on the target surface S at once. The index projector 53A, which is disposed above the target surface S of the workpiece W on the base 10 and on a positive side relative to the workpiece W in an X-axis direction, projects the indexes 52 at least in the overlapping areas AL where the measurement areas A overlap.

Incidentally, when the target surface S of the workpiece W is a mirrored surface, a projection beam Lp is reflected by the target surface S and thus none of the indexes 52 appears on the target surface S. However, the target surface S of the workpiece W usually measured with the grazing incidence interferometer 1A is rough. Therefore, the projection beam Lp is irregularly reflected on the target surface S and thus the indexes 52 appear.

Incidentally, the projection beam Lp from the index projector 53A may have a wavelength identical to or different from that of the raw light Lg.

The index-image capturing unit 60A, which is disposed in the interferometer body 30 at a position where the combined beam Ld is not incident, captures images of the indexes 52 appearing in the measurement areas A. For instance, the index-image capturing unit 60A may be a CCD (Charge-Coupled Device) camera and is disposed right above the measurement areas A to face the target surface S. It should be noted that an image-capturing range of the index-image capturing unit 60A and an image-capturing range of the image capturing unit 45 may be mutually the same or different.

The image capturing state setting unit 70A is configured to switch on and off the index projector 53A to turn on and off the projection beam Lp. The image capturing state setting unit 70A switches off the index projector 53A to stop emission of the projection beam Lp so that the image capturing unit 45 can capture an interference fringe image showing the measurement area A but none of the indexes 52. Further, the image capturing state setting unit 70A switches on the index projector 53A to emit the projection beam Lp so that the index-image capturing unit 60A can capture an index image showing the indexes 52.

The measuring unit 46A includes an image acquiring unit 461A and a profile computing unit 462A.

At an image-capturing position for each of the measurement areas A, the image acquiring unit 461A controls the image capturing state setting unit 70A so that the image capturing unit 45 captures an interference fringe image showing the measurement area A but none of the indexes 52, and acquires the interference fringe image. Further, after or before acquiring the above interference fringe image, the image acquiring unit 461A controls the image capturing state setting unit 70A so that the index-image capturing unit 60A captures an index image showing the indexes 52, and acquires the index image.

Subsequently, the image acquiring unit 461A controls the relative movement mechanism 20, the interferometer body 30 and the image capturing state setting unit 70A to perform stepping measurement of the plurality of measurement areas A defined in the target surface S.

The profile computing unit 462A computes a positional relationship between the index images of adjacent ones of the measurement areas A in which images of the index 52 included in common in these index images are superimposed on each other, and combines the interference fringe images of adjacent ones of the measurement areas in conformity with the positional relationship to obtain the surface profile of the target surface S.

An operation according to the second exemplary embodiment will be described.

First, the image acquiring unit 461A moves the interferometer body 30 with the relative movement mechanism 20 to that the interferometer body 30 is set at the first measurement position. In measuring the target surface S, the image acquiring unit 461A controls the image capturing state setting unit 70A to switch on and off the index projector 53A to acquire from the image capturing unit 45 an interference fringe image showing the measurement area A but none of the indexes 52 and acquire from the index-image capturing unit 60A an index image showing the indexes 52. The image acquiring unit 461A repeats the above process at subsequent measurement positions.

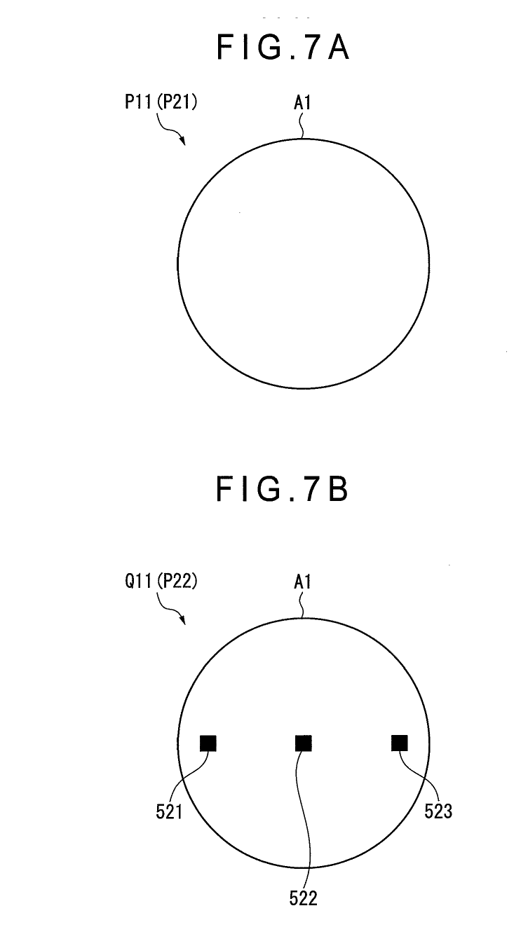

For instance, as shown in FIG. 3A, the indexes 521 to 523, 523 to 525, 525 to 527 may respectively appear in the measurement areas A1, A2, A3. In this case, the image acquiring unit 461A acquires an interference fringe image P11 showing the measurement area A1 but none of the indexes 521, 522, 523 as shown in FIG. 7A. The image acquiring unit 461A also acquires an index image Q11 showing both of the measurement area A1 and the indexes 521, 522, 523 as shown in FIG. 7B. Further, the image acquiring unit 461A sequentially acquires similar interference fringe images and index images of measurement areas A2, A3. Based on the acquired interference fringe images, the image acquiring unit 461A obtains measurement results of the measurement areas A1, A2, A3.

When measurement is completed at all the measurement positions, the profile computing unit 462A combines measurement results based on the interference fringe images of adjacent ones of the measurement areas A with the assistance of the indexes 52 to obtain a measurement result of the entire target surface S.

For instance, the profile computing unit 462A obtains a positional relationship between the index image Q11 of the measurement area A1 and the index image of the measurement area A2 in which images of the index 523 included in common in these index images are superimposed on each other, and combines a measurement result based on the interference fringe image P11 of the measurement area A1 and a measurement result based on the interference fringe image of the measurement area A2 in conformity with the positional relationship. The profile computing unit 462A repeats the above process for the other measurement areas to obtain the surface profile of the target surface S.

The second exemplary embodiment provides the following effects (2) to (4).
(2) The measuring unit 46A obtains the measurement result of the target surface S by computing a positional relationship between adjacent ones of the index images in which images of the index 52 included in common in these index images are superimposed on each other, and combining measurement results based on the interference fringe images corresponding to these index images in conformity with the positional relationship. A decrease in measurement accuracy and measurement resolution can thus be suppressed as in the first exemplary embodiment. Further, since measurement results based on the interference fringe images showing none of the indexes 52 are combined, the resulting surface profile is devoid of voids corresponding to the indexes 52.
(3) Since the indexes 52 are projected by the index projector 53A, the indexes 52 can appear on the target surface S anytime as required.
(4) The image capturing state setting unit 70A is configured to switch on and off the index projector 53A. Therefore, the interference fringe image showing none of the indexes 52 and the index image showing the indexes 52 can be captured by simply switching on and off the index projector 53A.

### Third Exemplary Embodiment

Next, a grazing incidence interferometer according to a third exemplary embodiment of the invention will be described.

It should be noted that arrangements similar to those of the second exemplary embodiment are attached with the like reference signs and the explanation thereof is omitted.

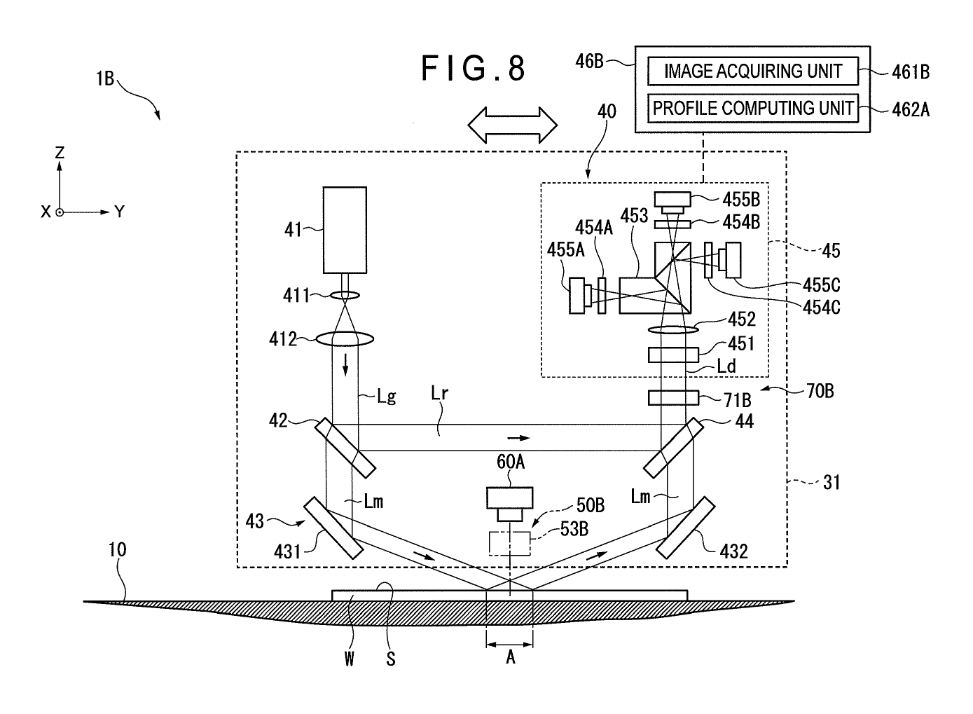

As shown in FIG. 8, a grazing incidence interferometer 1B is different from the grazing incidence interferometer 1A of the second exemplary embodiment in that a measuring unit 46B, an index displaying unit 50B and an image capturing state setting unit 70B are provided in place of the measuring unit 46A, the index displaying unit 50A and the image capturing state setting unit 70A.

The index displaying unit 50B includes an index projector 53B disposed and configured in the same manner as the index projector 53A of the second exemplary embodiment. The projection beam Lp from the index projector 53B is designed to have a second wavelength different from the wavelength (the first wavelength) of the raw light Lg from the light source 41.

The image capturing state setting unit 70B includes a filter 71B that is disposed in the optical path of the combined beam Ld and serves as a wavelength selector that allows light with the first wavelength to be incident on the image capturing unit 45 but does not allow light with the second wavelength to be incident on the image capturing unit 45. The filter 71B, which is disposed between the beam combiner 44 and the quarter-wave plate 451, absorbs or reflects light with the second wavelength. With the filter 71B, even when the indexes 52 are continuously projected by the index projector 53B and thus continue to appear on the target surface S, the measurement beam Lm with the first wavelength, which has been incident on appearing portions of the indexes 52, is incident on the image capturing unit 45, whereas the light with the second wavelength for displaying the indexes 52 is not incident. In other words, the image capturing unit 45 can capture an interference fringe image that shows none of the indexes 52 and is devoid of voids corresponding to the indexes 52.

The measuring unit 46B includes an image acquiring unit 461B and the profile computing unit 462A.

At an image-capturing position for each of the measurement areas A, the image acquiring unit 461B acquires an interference fringe image showing the measurement area A but none of the indexes 52 captured by the image capturing unit 45 and an index image showing the indexes 52 captured by the index-image capturing unit 60A. Since the interference fringe image that shows none of the indexes 52 and is devoid of voids corresponding to the indexes 52 can be captured by the image capturing unit 45 even when the index projector 53B continuously projects the indexes 52 as described above, the image acquiring unit 461B can acquire the interference fringe image and the index image while the index projector 53B is switched on, unlike the image acquiring unit 461A of the second exemplary embodiment.

The image acquiring unit 461B controls the relative movement mechanism 20 and the interferometer body 30 to perform stepping measurement of the plurality of measurement areas A defined in the target surface S.

An operation according to the third exemplary embodiment will be described.

First, at a first measurement position, the image acquiring unit 461B switches on the index projector 53B, and acquires an interference fringe image showing none of the indexes 52 from the image capturing unit 45 and an index image showing the indexes 52 from the index-image capturing unit 60A to perform measurement of the target surface S. The image acquiring unit 461B repeats the above process at subsequent measurement positions.

For instance, when the indexes 521 to 523, 523 to 525, 525 to 527 respectively appear in the measurement areas A1, A2, A3 as shown in FIG. 3A, the image acquiring unit 461B acquires the interference fringe image P11 and the index image Q11 of the measurement area A1, which are respectively shown in FIGS. 7A, 7B, and performs measurement.

When measurement is completed at all the measurement positions, the profile computing unit 462A combines measurement results based on the interference fringe images of adjacent ones of the measurement areas A with the assistance of the indexes 52 to obtain a measurement result of the entire target surface S as in the second exemplary embodiment.

The third exemplary embodiment provides the following effect (5) in addition to effects similar to the effects (2) and (3) of the second exemplary embodiment.
(5) The projection beam Lp is designed to have the second wavelength different from the first wavelength of the raw light Lg and the filter 71B is disposed in the optical path of the combined beam Ld, the filter 71B allowing light with the first wavelength to be incident on the image capturing unit 45 but not allowing light with the second wavelength to be incident on the image capturing unit 45. Therefore, even when the indexes 52 are continuously projected by the index projector 53B and thus continue to appear on the target surface S, an interference fringe image that shows none of the indexes 52 and is devoid of voids corresponding to the indexes 52 and an index image that shows the indexes 52 can be captured, which results in obtaining a measurement result based on the entire image-captured measurement areas. Further, with a combination of the image capturing unit 45 and the index-image capturing unit 60A, the interference fringe image and the index image can be simultaneously captured to reduce measurement time.

### Fourth Exemplary Embodiment

Next, a grazing incidence interferometer according to a fourth exemplary embodiment of the invention will be described.

It should be noted that arrangements similar to those of the first exemplary embodiment are attached with the like reference signs and the explanation thereof is omitted.

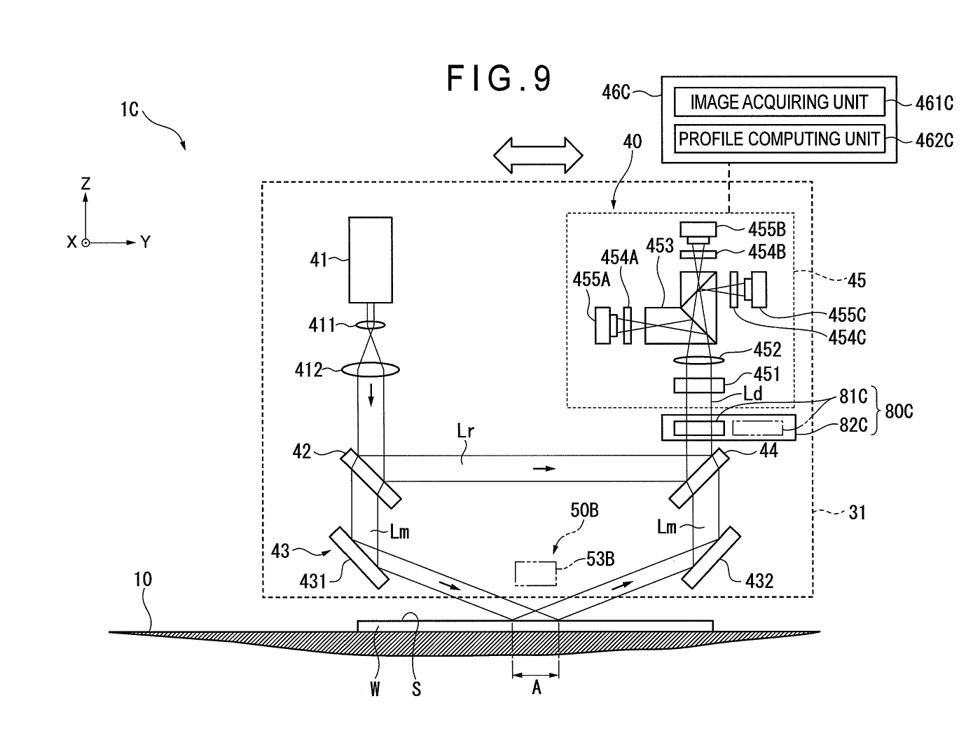

As shown in FIG. 9, a grazing incidence interferometer 1C is different from the grazing incidence interferometer 1 of the first exemplary embodiment in that a measuring unit 46C and an index displaying unit 50B are provided in place of the measuring unit 46 and the graduated instrument 50 and an image capturing state switching unit 80C is newly added.

The image capturing state switching unit 80C is configured to switch a first image capturing state and a second image capturing state. In the first image capturing state, the raw light Lg from the light source 41 can be incident on the image capturing unit 45 whereas the projection beam Lp from the index projector 53B cannot be incident on the image capturing unit 45. In the second image capturing state, at least the projection beam Lp out of the raw light Lg and the projection beam Lp can be incident on the image capturing unit 45. The image capturing state switching unit 80C includes a filter 81C and a filter moving unit 82C.

The filter 81C transmits light with the first wavelength but not light with the second wavelength. The filter 81C may be one similar to the filter 71B of the third exemplary embodiment.

The filter moving unit 82C moves the filter 81C into the optical path of the combined beam Ld as shown in a solid line in FIG. 9 to set the first image capturing state and moves the filter 81C to a position out of the optical path of the combined beam Ld to set the second image capturing state as shown in a chain double-dashed line in FIG. 9. The filter moving unit 82C may horizontally move the filter 81C in an X- or Y-axis direction or may turn the filter 81C around an axis parallel with a Z-axis.

With the filter 81C similar to the filter 71B of the third exemplary embodiment, even when the indexes 52 are continuously projected by the index projector 53B and thus continue to appear on the target surface S, a first interference fringe image that shows none of the indexes and is devoid of voids corresponding to the indexes 52 can be captured by the image capturing unit 45 as in the third exemplary embodiment.

The measuring unit 46C includes an image acquiring unit 461C and a profile computing unit 462C.

At an image-capturing position for each of the measurement areas A, the image acquiring unit 461C controls the filter moving unit 82C of the image capturing state switching unit 80C to set the first image capturing state so that the first interference fringe image showing the measurement area A but none of the indexes 52 is captured by the image capturing unit 45. Further, after or before acquiring the first interference fringe image, the image acquiring unit 461C controls the filter moving unit 82C to set the second image capturing state so that a second interference fringe image showing the indexes 52 is captured by the image capturing unit 45.

Subsequently, the image acquiring unit 461C controls the relative movement mechanism 20, the interferometer body 30 and the image capturing state switching unit 80C to perform stepping measurement of the plurality of measurement areas A defined in the target surface S.

The profile computing unit 462C computes a positional relationship between the second interference fringe images of adjacent ones of the measurement areas A in which images of the index 52 included in common in these second interference fringe images are superimposed on each other, and combines the first interference fringe images of the adjacent ones of the measurement areas A in conformity with the positional relationship to obtain the surface profile of the target surface S.

An operation according to the fourth exemplary embodiment will be described.

First, when the first measurement position is reached, the image acquiring unit 461C controls the filter moving unit 82C to advance/retract the filter 81C into/from the optical path of the combined beam Ld, and acquires from the image capturing unit 45 the first interference fringe image, which shows the measurement area A but none of the indexes 52, and the second interference fringe image, which shows both the first measurement area A and the indexes 52, to measure the target surface S. The image acquiring unit 461C repeats the above process at subsequent measurement positions.

For instance, when the indexes 521 to 523, 523 to 525, 525 to 527 respectively appear in the measurement areas A1, A2, A3 as shown in FIG. 3A, the image acquiring unit 461C acquires a first interference fringe image P21 and a second interference fringe image P22 of the measurement area A1, which are respectively shown in FIGS. 7A, 7B, and performs measurement.

When measurement is completed at all the measurement positions, the profile computing unit 462C combines measurement results based on the first interference fringe images of adjacent ones of the measurement areas A with the assistance of the indexes 52 shown in the second interference fringe images to obtain a measurement result of the entire target surface S.

For instance, the profile computing unit 462C computes a positional relationship between the second interference fringe image P22 of the measurement area A1 and a second interference fringe image of the measurement area A2 in which images of the index 523 included in common in these second interference fringe images are superimposed on each other, and combines a measurement result based on the first interference fringe image P21 of the measurement area A1 and a measurement result based on a first interference fringe image of the measurement area A2 in conformity with the positional relationship. The profile computing unit 462C repeats the above process for the other measurement areas to obtain the surface profile of the target surface S.

The fourth exemplary embodiment provides the following effects (6) and (7) as well as effects similar to the effect (1) of the first exemplary embodiment and the effect (3) of the second exemplary embodiment.
(6) The measuring unit 46C combines measurement results based on the first interference fringe images of adjacent ones of the measurement areas A, which show none of the indexes 52, in conformity with a positional relationship in which the images of the index 52 included in common in the corresponding second interference fringe images are superimposed on each other. Therefore, the resulting surface profile is devoid of voids corresponding to the indexes 52 and thus a measurement result based on the entire image-captured measurement areas A can be obtained.
(7) The filter moving unit 82C is configured to advance/retract the filter 81C into/from the optical path of the combined beam Ld. Therefore, even when the projection beam Lp is continuously projected by the index projector 53B, the first interference fringe images showing none of the indexes 52 and the second interference fringe images showing the indexes 52 can be captured by simply moving the filter 81C.

### Modification(s)

Incidentally, it should be understood that the scope of the invention is not limited to the above-described exemplary embodiments but includes modifications and improvements as long as the modifications and improvements are compatible with the invention.

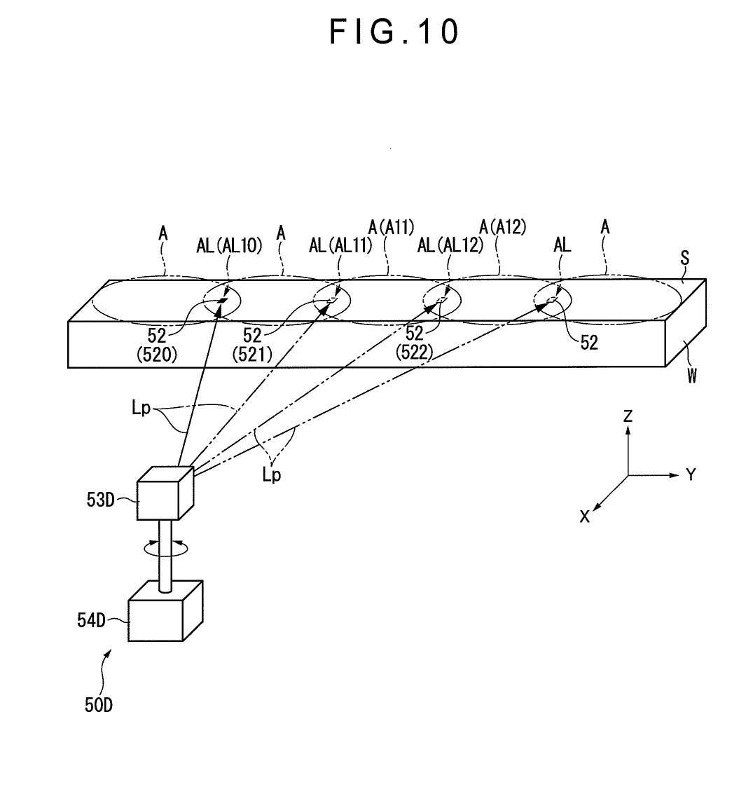

For instance, in any one of the second to fourth exemplary embodiments, the index displaying unit 50A or 50B may be replaced by an index displaying unit 50D shown in FIG. 10.

The index displaying unit 50D includes: an index projector 53D that projects a single index 52 on the target surface S at once; and a projected position adjuster 54D that turns the index projector 53D to adjust an appearing position of the index 52. The projection beam Lp from the index projector 53D is designed to have a wavelength that may be the same as the wavelength of the raw light Lg when the index displaying unit 50D is used in the second exemplary embodiment, and have a wavelength designed as the second wavelength that is not transmitted through the filter 71B or 81C when the index displaying unit 50D is used in the third or fourth exemplary embodiment. In the index displaying unit 50D, the index projector 53D is turned in accordance with the transition of the measurement position to adjust the appearing position of the index 52 (scan the index 52), thereby obtaining effects similar to those of the second to fourth exemplary embodiments.

In the second exemplary embodiment, the following process may be performed for each of the measurement areas A to capture the index image showing the indexes 52 and the interference fringe image showing none of the indexes 52. For instance, when the interferometer body 30 is set at a position for measuring a measurement area A11 and the index projector 53D is oriented to project the index 521 on an overlapping area AL11, the index projector 53D is switched on and off so that an index image of the measurement area A11 showing the index 521 in the overlapping area AL11 and an interference fringe image of the measurement area A11 not showing the index 521 in the overlapping area AL11 are captured. Subsequently, the projected position adjuster 54D adjusts the orientation of the index projector 53D to project the index 522 on an overlapping area AL12 so that the index image of the measurement area A11 showing the index 522 in the overlapping area AL12 is captured.

It should be noted that the following process may alternatively be performed to capture the index image and the interference fringe image without switching off the index projector 53D. For instance, while an index 520 is projected on an overlapping area AL10, the interferometer body 30 is moved to the position for measuring the measurement area A11 to capture the interference fringe image of the measurement area A11 not showing the index 521 in the overlapping area AL11. The index projector 53D is then turned while being switched on to project the index 521 on the overlapping area AL11 so that the index image of the measurement area A11 showing the index 521 is captured. The index projector 53D is further turned while being switched on to project the index 522 on the overlapping area AL12 so that the index image of the measurement area A11 showing the index 522 is captured. Then, the index projector 53D is further turned by the projected position adjuster 54D while being switched on to project the index 521 on the overlapping area AL11, and the interferometer body 30 is moved to a position for measuring the measurement area A12 to capture an interference fringe image of the measurement area A12 not showing the index 522 in the overlapping area AL12.

In the third exemplary embodiment, the following process may be performed to capture an index image, which shows the indexes 52, and an interference fringe image, which shows none of the indexes 52, of each of the measurement areas A. For instance, when the interferometer body 30 is set at a position for measuring the measurement area A11 and the index 521 is projected on the overlapping area AL11 by the index projector 53D, the index image of the measurement area A11 showing the index 521 in the overlapping area AL11 and an interference fringe image of the measurement area A11 not showing the index 521 in the overlapping area AL11 are captured. Subsequently, the index projector 53D is turned by the projected position adjuster 54D while being switched on to project the index 522 on the overlapping area AL12 so that the index image of the measurement area A11 showing the index 522 in the overlapping area AL12 is captured.

In the fourth exemplary embodiment, the following process may be performed to capture a first interference fringe image and a second interference fringe image of each of the measurement areas A, the first interference fringe image not showing the index 52, the second interference fringe image showing the index 52. For instance, when the interferometer body 30 is set at a position to measure the measurement area A11 and the filter 81C is set in the optical path of the combined beam Ld, the index projector 53D projects the index 521 on the overlapping area AL11 so that a first interference fringe image of the measurement area A11 not showing the index 521 in the overlapping area AL11 is captured. Subsequently, the filter 81C is moved out of the optical path of the combined beam Ld while the index 521 is kept projected so that a second interference fringe image of the measurement area A11 showing the index 521 in the overlapping area AL11 is captured. The index projector 53D is then further turned by the projected position adjuster 54D while being switched on to project the index 522 on the overlapping area AL12 so that a second interference fringe image of the measurement area A11 showing the index 522 in the overlapping area AL12 is captured.

It should be noted that the projected position adjuster according to the invention may linearly move the index projector 53D in the Y-axis direction. Further, the index 52 may be scanned by an optical scanning technique such as mirror resonance using an MEMS (Micro Electro Mechanical System) mirror or by applying voltage to an optical element to change a refractive index.

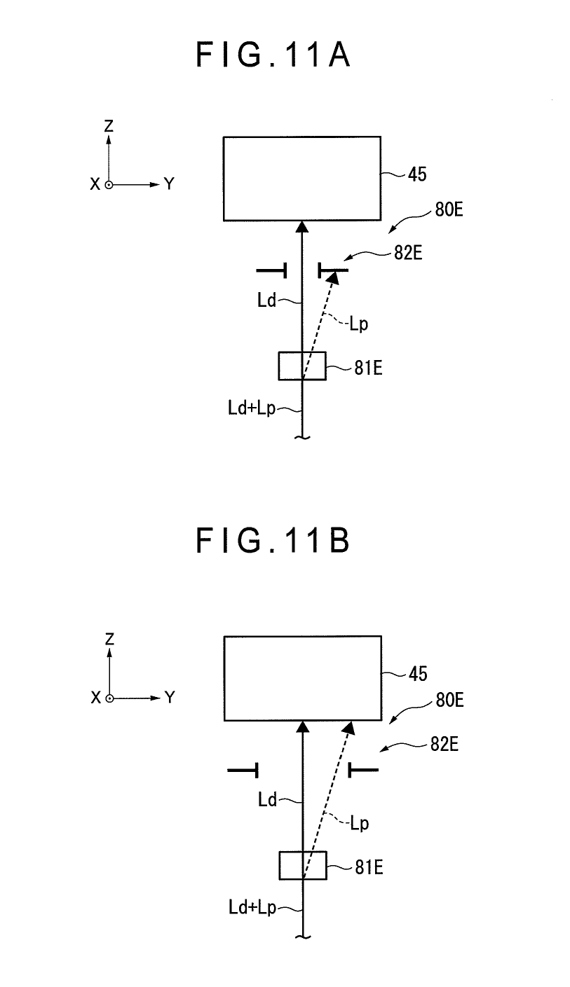

In the fourth exemplary embodiment, the image capturing state switching unit 80C may be replaced by an image capturing state switching unit 80E as shown in FIGS. 11A, 11B.

The image capturing state switching unit 80E includes a beam separator 81E and an aperture diaphragm 82E. The beam separator 81E, which is disposed in the optical path of the combined beam Ld, directs light with the first wavelength to the image capturing unit 45 and light with the second wavelength to be separated from the light with the first wavelength. The aperture diaphragm 82E is disposed between the beam separator 81E and the image capturing unit 45. The aperture diaphragm 82E is set in a first opened state to allow light with the first wavelength to pass therethrough but not allow light with the second wavelength to pass therethrough as shown in FIG. 11A, thereby achieving the first image capturing state, and is set in a second opened state to allow both light with the first wavelength and light with the second wavelength to pass therethrough as shown in FIG. 11B, thereby achieving the second image capturing state. It should be noted that the opened state of the aperture diaphragm 82E can be manually or mechanically adjusted.

In the third or fourth exemplary embodiment using the filter 71B or 81C or in the arrangement using the image capturing state switching unit 80E shown in FIGS. 11A, 11B, the index displaying unit 50B or 50C may be replaced by the graduated instrument 50 provided with the indexes 52 having a color corresponding to the second wavelength.

In the third or fourth exemplary embodiment using the filter 71B or 81C, the filter 71B or 81C may be disposed in the image capturing unit 45 at an upstream of the image sensors 455A to 455C.

In the fourth exemplary embodiment, the filter 81C may be manually advanced or retracted into or from the optical path of the combined beam Ld without disposing the filter moving unit 82C.

In the second exemplary embodiment, the projection beam Lp may be turned on and off by advancing and retracting a light shield in place of switching on and off the index projector 53B.

In the second exemplary embodiment, without disposing the index-image capturing unit 60A, the projection beam Lp may be turned on and off so that the image capturing unit 45 captures the first interference fringe image and the second interference fringe image according to the invention.

In the third exemplary embodiment, without disposing the image capturing state setting unit 70B, a color camera may be used as an image capturing unit in place of the image capturing unit 45. In this case, the measuring unit performs an image processing based on RGB signal components. For instance, when red-colored indexes 52 are projected, an interference fringe image showing the indexes 52 are color-separated into red, green and blue and then converted into an image only having blue and green channels, thereby obtaining an interference fringe image not showing the indexes 52.

In the third exemplary embodiment, without disposing the image capturing state setting unit 70B, the image capturing state switching unit 80E in the first opened state shown in FIG. 11A may be disposed.

In the above exemplary embodiments and modifications, the index(es) 52 may be in the form of a geometrical shape, a character or a combination thereof as long as the index(es) 52 can specify a direction in combining the measurement results. It should be noted that in the case that a single geometrical shape appears as the index 52 in the overlapping area AL between two of the measurement areas A, a perfect circle is preferably not used, whereas in the case that a combination of two or more geometrical shapes appears as the index 52, a perfect circle may be used. Appearing intervals between the indexes 52 may be the same or different. The indexes 52 may appear only in the overlapping areas AL.

In the exemplary embodiments and modifications, the workpiece W may be moved in place of moving the interferometer body 30.

What is claimed is:

1. A grazing incidence interferometer comprising:
a light source;
a beamsplitter configured to split raw light from the light source into a measurement beam and a reference beam;
a light irradiator configured to obliquely apply the measurement beam to a plurality of measurement areas defined in a target surface, individually;
a beam combiner configured to combine the measurement beam reflected by the target surface and the reference beam into a combined beam;
an image capturing unit configured to capture interference fringe images of the measurement areas based on the combined beam;
an interferometer body in which the light source, the beamsplitter, the light irradiator, the beam combiner and the image capturing unit are disposed;
a base configured to hold a workpiece having the target surface;
a relative movement mechanism configured to relatively move the interferometer body and/or the base in a manner that the measurement areas are aligned with one another and adjacent ones of the measurement areas partly overlap with each other;
an index displaying unit configured to show an index at a position where the adjacent ones of the measurement areas overlap with each other; and
a measuring unit configured to combine measurement results based on the interference fringe images of the measurement areas to obtain a surface profile of the target surface, the measuring unit comprising:
an image acquiring unit configured to acquire the interference fringe images of the measurement areas at image-capturing positions for the measurement areas, individually, the interference fringe images each showing the index and one of the measurement areas; and
a profile computing unit configured to combine the measurement results based on the interference fringe images of the adjacent ones of the measurement areas in a manner that images of the index comprised in common in the interference fringe images of the adjacent ones of the measurement areas are superimposed on each other to obtain the surface profile.

2. The grazing incidence interferometer according to claim 1, wherein the index displaying unit comprises an index projector configured to project the index on the target surface.

3. The grazing incidence interferometer according to claim 2, further comprising an image capturing state switching unit configured to switch: a first image capturing state where the raw light from the light source is to be incident on the image capturing unit whereas a projection beam from the index projector is not to be incident on the image capturing unit; and a second image capturing state where at least the projection beam out of the raw beam and the projection beam is to be incident on the image capturing unit, wherein
the image acquiring unit controls the image capturing state switching unit at the image-capturing positions for the measurement areas to acquire the interference fringe images of the measurement areas, individually, the interference fringe images each comprising: a first interference fringe image that is captured in the first image capturing state and shows the one of the measurement areas but not shows the index; and a second interference fringe image that is captured in the second image capturing state and shows the index, and
the profile computing unit: computes a positional relationship between the second interference fringe images of the adjacent ones of the measurement areas in which the images of the index comprised in common in the second interference fringe images of the adjacent ones of the measurement areas are superimposed on each other; and combines the measurement results based on the first interference fringe images of the adjacent ones of the measurement areas in conformity with the positional relationship.

4. The grazing incidence interferometer according to claim 3, wherein
a wavelength of the raw light is defined as a first wavelength,
a wavelength of the projection beam from the index projector is defined as a second wavelength different from the first wavelength, and
the image capturing state switching unit comprises:
a filter configured to transmit light with the first wavelength but not light with the second wavelength; and
a filter moving unit configured to move the filter into an optical path of the combined beam to achieve the first image capturing state and move the filter out of the optical path of the combined beam to achieve the second image capturing state.

5. A grazing incidence interferometer comprising:
a light source;
a beamsplitter configured to split raw light from the light source into a measurement beam and a reference beam;
a light irradiator configured to obliquely apply the measurement beam to a plurality of measurement areas defined in a target surface, individually;
a beam combiner configured to combine the measurement beam reflected by the target surface and the reference beam into a combined beam;
an image capturing unit configured to capture interference fringe images of the measurement areas based on the combined beam;
an interferometer body in which the light source, the beamsplitter, the light irradiator, the beam combiner and the image capturing unit are disposed;
a base configured to hold a workpiece having the target surface;
a relative movement mechanism configured to relatively move the interferometer body and/or the base in a manner that the plurality of measurement areas are aligned with one another and adjacent ones of the measurement areas partly overlap with each other;
an index displaying unit comprising an index projector configured to project an index to a position where the adjacent ones of the measurement areas overlap with each other; and
an index-image capturing unit disposed in the interferometer body at a position where the combined beam is not incident to capture index images of the measurement areas showing the index in the measurement areas;
an image capturing state setting unit configured to achieve a state where the interference fringe images showing the measurement areas but not showing the index are to be captured by the image capturing unit whereas the index images showing the index are to be captured by the index-image capturing unit; and
a measuring unit configured to combine measurement results based on the interference fringe images of the measurement areas to obtain a surface profile of the target surface, the measuring unit comprising:
an image acquiring unit configured to acquire the interference fringe images and the index images of the measurement areas at image-capturing positions for the measurement areas, individually;
a profile computing unit configured to obtain the surface profile by: computing a positional relationship between the index images of the adjacent ones of the measurement areas in which images of the index comprised in common in the index images are superimposed on each other; and combining the measurement results based on the interference fringe images of the adjacent ones of the measurement areas in conformity with the positional relationship.

6. The grazing incidence interferometer according to claim 5, wherein
a wavelength of the raw light is defined as a first wavelength,
a wavelength of a projection beam from the index projector is defined as a second wavelength different from the first wavelength, and
the image capturing state setting unit comprises a wavelength selector disposed in an optical path of the combined beam so that light with the first wavelength is to be incident on the image capturing unit whereas light with the second wavelength is not to be incident on the image capturing unit.
